(19) United States
(12) Patent Application Publication
(10) Pub. No.: US 2019/0228618 A1
(43) Pub. Date: Jul. 25, 2019

(54) METHOD FOR UTILIZING A PHOSPHORESCENT SKID TO TRACK THE LOCATION OF A SEWAGE HOSE THROUGH DARK SEWAGE PIPES

(71) Applicant: Luca Marin, Temecula, CA (US)

(72) Inventor: Luca Marin, Temecula, CA (US)

(21) Appl. No.: 16/254,472

(22) Filed: Jan. 22, 2019

Related U.S. Application Data
(60) Provisional application No. 62/619,997, filed on Jan. 22, 2018.

(51) Int. Cl. G08B 5/36; F16L 55/48

(52) U.S. Cl. CPC G08B 5/36; C09K 11/7728; F16L 55/48

(57) ABSTRACT

A method for tracking the location of a sewage hose. A sewage main line hose is connected to a sewage truck. A leader hose is connected to the end of the main line hose. A phosphorescent skid is connected to the leader hose. A nozzle is connected to the end of the phosphorescent skid. The nozzle, leader hose, main hose and phosphorescent skid are moved through the sewage line. The glow of the phosphorescent skid is observable through the dark sewage line. The location of the main line hose and the nozzle can be easily determined after observing the glow from the phosphorescent skid. In a preferred embodiment the phosphorescent skid utilizes europium phosphorescent powder for its phosphorescent properties.

The present invention relates to high pressure sewage hoses, and in particular, to methods for viewing the location of high-pressure sewage hoses in dark locations. This application claims the benefit of U.S. Provisional Application No. 62/619,997, filed Jan. 22, 2018.

### BACKGROUND OF THE INVENTION

In the sewage waste water industry, high pressure hoses are needed to clear and clean the sewage pipes. Sewage trucks are utilized that have large reels having the high pressure main line water hoses. Sewage trucks are also known as combination sewer cleaning trucks, combination trucks, jetters or jetter trucks. The main line can be of varying lengths up to approximately 1000 feet and can have a working pressure of anywhere from 2000-3000 psi. The main line hoses are color-coordinated with the color referring to the water pressure that the truck's pumps can generate.

At the beginning and end of the main line hose there is a leader hose (also referred to as a guide hose or Pilot hose). The leader hoses are more flexible and they have a higher working pressure than the main line hose. The leader hoses are used to lead the main line hose around turns and bends. A high-pressure nozzle is connected to the end of the leader hose.

As an industry standard the leader hoses are black. They are extremely difficult to see in dark sewage lines. Workers may use mirrors or flashlights to help them see in the sewage line.

A function of the leader hose is to let the worker know the distance from the nozzle to the end of the main line hose. For example, the workers may see that they have 10 feet left or 15 feet left depending on the length of the leader hose. Leader hoses may be as long as 25 feet. It is important to know where the main line hose is in order to save the main line hose from any unnecessary damage. Unfortunately, as stated above, leader hoses are very hard to see because they are black. Also, manhole depths can be high, up to 30 feet.

FIGS. 4 and 5 show perspective views of prior art skids 30 and 40. A skid may be attached to the end of the leader hose. Skids are also commonly referred to as a nozzle extension or a proofer. Skids are available in various sizes, lengths and shapes. Some skids may even have wheels on them. Different types of skids available include: a football style skid, a fin style skid, a wire style skid, a football style proofer or a wheeled nozzle extension.

The nozzle that is used during jetting attaches directly to the skid. The skid that is chosen is picked according to the size of pipe that is being cleaned. The skid is used for various reasons, including: a) keeping the nozzle from flipping around and shooting back at the operator, b) keeping the nozzle centered in the line so that the nozzle can clean properly, and c) keeping the nozzle and the line from going up laterals that are connected to the main line.

Skids also let the user know whether the line is clear. If the skid cannot get through the line that is and indication that there is an obstruction of some kind that is stopping it from going forward. The worker knows that if the skid can get through the line then that is “proof” the line is clear. This is why skids are sometimes referred to as “proofers”. Skids also function to keep the nozzles weighted down.

Most of the skids are either black just a regular steel color or gray. This can be a problem when a worker is looking into a 25 to 30-foot-deep manhole and it is dark with no light source. It is also at times difficult to locate the end of the line or its location because the worker cannot see it in the dark.

### Europium Phosphorescent Material

Europium phosphorescent powders are a new generation of glow material. The europium phosphorescent powder provides glow much better than the zinc sulfide phosphorescent materials more commonly known. For example, green and aqua glow europium phosphorescent powders will remain clearly visible for as long a 30 hours after sufficient light exposure. The length of time a glow powder will glow is defined as the time it takes for the afterglow brightness to diminish to 0.32 mod (0.32 mod is 100 times the human visible perception limit). Even at this level, the glow is clearly visible in darkness. Europium phosphorescent powder is available from United Nuclear Scientific with offices in Laingsburg, Mich. (website address: www.unitednuclear.com).

### SUMMARY OF THE INVENTION

The present invention provides a method for tracking the location of a sewage hose. A sewage main line hose is connected to a sewage truck. A leader hose is connected to the end of the main line hose. A phosphorescent skid is connected to the leader hose. A nozzle is connected to the end of the phosphorescent skid. The nozzle, leader hose, main hose and phosphorescent skid are moved through the sewage line. The glow of the phosphorescent skid is observable through the dark sewage line. The location of the main line hose and the nozzle can be easily determined after observing the glow from the phosphorescent skid. In a preferred embodiment the phosphorescent skid utilizes europium phosphorescent powder for its phosphorescent properties.

### BRIEF DESCRIPTION OF THE DRAWINGS

FIG. 1 shows a preferred phosphorescent skid base.

FIGS. 2-4 show preferred phosphorescent skids.

FIGS. 5-6 show prior art skids.

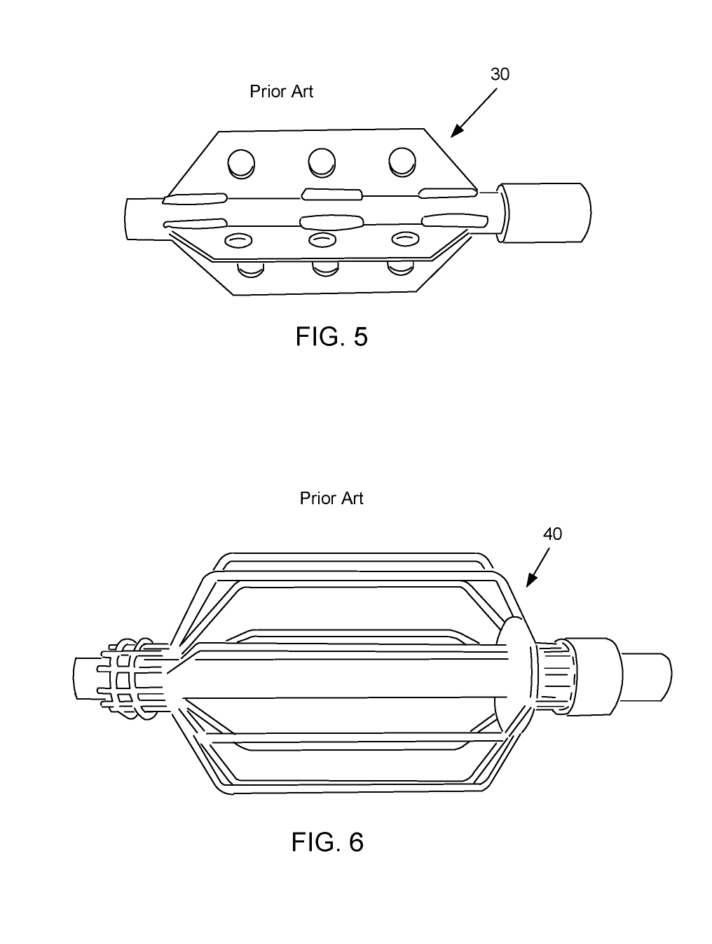

FIGS. 7-8 show the utilization of a preferred embodiment of the present invention.

### DETAILED DESCRIPTION OF THE PREFERRED EMBODIMENTS

In a preferred embodiment of the present invention, a clear medium (for example: epoxy, polyurethane, clear paint, or rubber) is infused with a phosphorescent material. Preferably, the phosphorescent material is europium phosphorescent powder. A phosphorescent medium is then created.

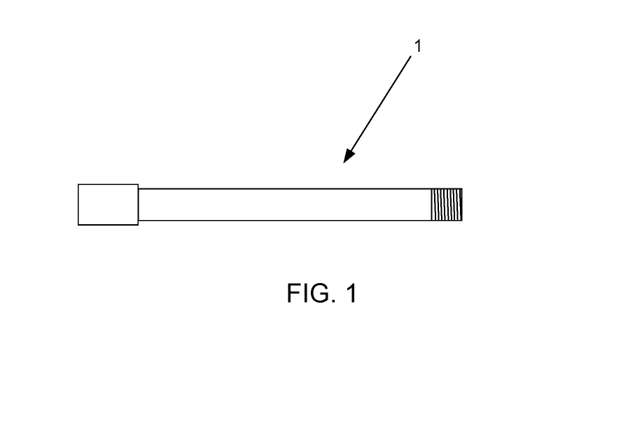

Skid base 1 (FIG. 1) is then coated in the phosphorescent medium. Skid base 1 will glow after being exposed to light for a period of time. Preferably, the light source utilized for charging skid base 1 is an ultraviolet (UV) light source. For example, a UV light source can fully charge skid base 1 in 10 minutes. Skid base 1 can also be charged by sunlight, a flashlight, and a light source that gives off UV rays. Given the proper mixing ratios the glow from skid base 1 can last up to 30 hours without ever needing to recharge. The glow will begin with an extremely bright glow depending on the mixing ratios and then to a moderate glow slowly diminishing over time.

### Examples

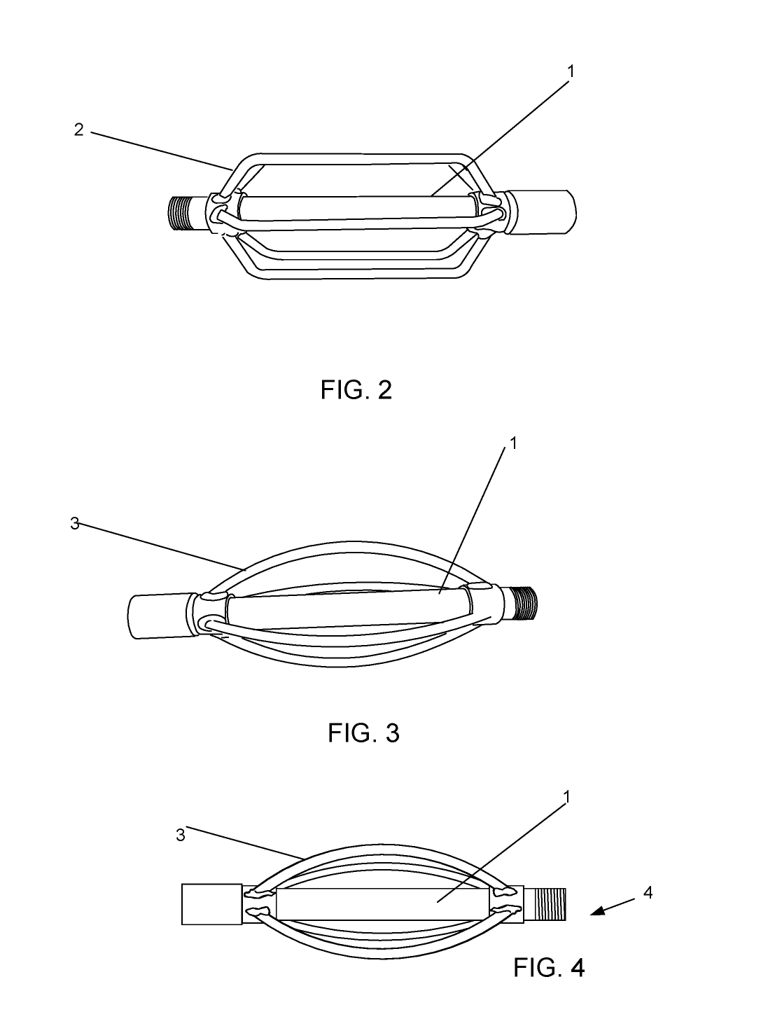

FIG. 2 shows skid base 1 coated in a medium infused with europium phosphorescent. Skid base 1 is surrounded by skid fins 2.

FIGS. 3 and 4 shows skid 4. Skid 4 includes skid base 1 surrounded by skid fins 3. Skid base 1 is coated in a medium infused with europium phosphorescent.

### Utilization of Phosphorescent Skid

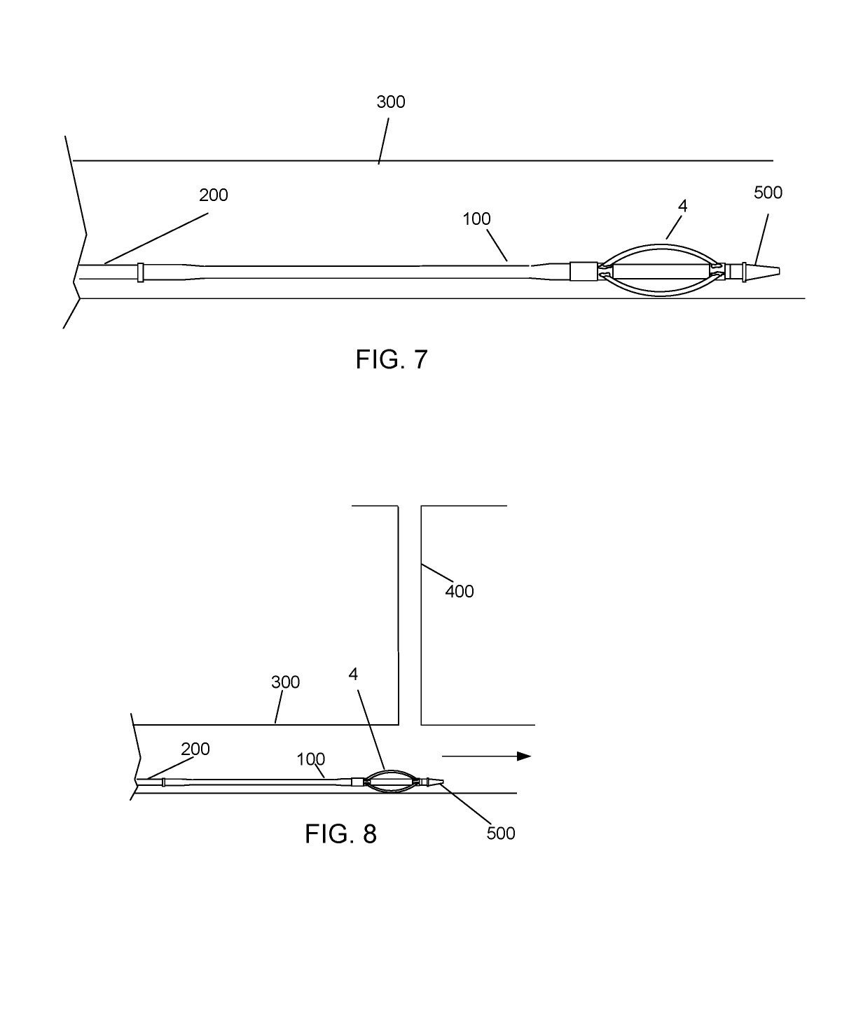

FIG. 7 shows main line hose 200 inserted into sewer 300. Leader hose 100 is connected to the distal end of main line hose 200 as shown. Skid 4 is threaded onto leader hose 100 and nozzle 500 is threaded onto skid 4. As explained above, skid 4 is phosphorescent. This allows a worker walking through sewer 300 to realize when he is approaching the end of the hose. Skid 4 emits a long-lasting light that can last up to approximately 30 hours. Therefore, a worker will not need to rely on a flashlight to know when he is approaching the end of the hose.

In FIG. 8 a worker is positioned at the top of manhole 400. The distance from top of manhole 400 to sewer line 300 is approximately 30 feet. The worker can easily see the glow of phosphorescent skid 4 from the top of manhole 400. By viewing the presence of skid 4, the worker has a very good understanding the position of main line hose 200 and nozzle 500 as main line hose 200 is being pulled through sewer line 300.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A method for tracking the location of a sewage hose, comprising the steps of:
A. obtaining a main line hose,
B. connecting said main line hose to a truck, said main hose distal end,
C. connecting a leader hose to said main line hose distal end, said leader hose having a known length,
D. connecting a phosphorescent skid to said leader hose,
E. connecting a nozzle to said phosphorescent skid,
F. moving said nozzle, said leader hose, said main hose and said phosphorescent skid through a sewage line,
G. observing said the glow of said phosphorescent skid in said sewage line, and
H. calculating the location of said main line hose and said nozzle after said step of observing said glow.

2. The method as in claim 1, wherein safety is increased for workers in dark sewer due to said step of observing said glow.

3. The method as in claim 1, wherein said phosphorescent skid coated in a medium infused with europium phosphorescent.

4. The method as in claim 1, wherein said skid comprises a skid base surrounded by a plurality of skid fins.

5. The method as in claim 4, wherein said skid base is a phosphorescent skid base.

6. The method as in claim 5, wherein said plurality of skid fins is non-phosphorescent.
